(19) United States
(12) Patent Application Publication
(10) Pub. No.: US 2018/0275887 A1
(43) Pub. Date: Sep. 27, 2018

(54) Data Storage Device and Operating Method of Data Storage Device

(71) Applicant: Silicon Motion, Inc., Jhubei City (TW)

(72) Inventors: Yi-Chien Yang, Tainan City (TW); Wu-Chi Kuo, Zhubei City (TW); Yu-Wei Fan, Taipei City (TW)

(73) Assignee: Silicon Motion, Inc.

(21) Appl. No.: 15/802,130

(22) Filed: Nov. 2, 2017

(30) Foreign Application Priority Data
Mar. 27, 2017 (TW) 106110108

(51) Int. Cl. G06F 3/06; G06F 12/1009

(52) U.S. Cl. CPC G06F 3/0608; G06F 12/1009; G06F 2212/1044; G06F 3/0652; G06F 3/0673; G06F 3/064

(57) ABSTRACT

A data storage device with high reliability. When rebuilding a mapping table, a validity table bitMap within a first block is taken into consideration to determine which is a newer version: the first data within the first block or the second data within a second block. The first block was originally used as a destination block for garbage collection. The second block was originally used as an active block for reception of write data from a host. The validity table bitMap shows the data status (valid or invalid) of the storage units of the first block. The first data and the second data relate to the same logical address.

### CROSS REFERENCE TO RELATED APPLICATIONS

This Application claims priority to Taiwan Patent Application No. 106110108, filed on Mar. 27, 2017, the entirety of which is incorporated by reference herein.

### BACKGROUND OF THE INVENTION

### Field of the Invention

The present invention relates to data storage devices and in particular to reconstruction of a mapping table for a data storage device.

### Description of the Related Art

There are various forms of nonvolatile memory (NVM) used in data storage devices for long-term data retention, such as a flash memory, magnetoresistive RAM, ferroelectric RAM, resistive RAM, spin transfer torque-RAM (STT-RAM), and so on.

The use of a nonvolatile memory needs to be managed by a mapping table. The mapping between logical addresses used on the host side and physical addresses on the NVM side is recorded in the mapping table. How to manage the mapping table is an important issue in the field of technology. In particular, a technique of accurately reconstructing a mapping table is required in order to deal with the destruction or loss of the mapping table.

### BRIEF SUMMARY OF THE INVENTION

A data storage device in accordance with an exemplary embodiment of the disclosure includes a nonvolatile memory and a microcontroller. The nonvolatile memory includes a plurality of physical blocks. When scanning the nonvolatile memory to reconstruct a mapping table between a host and the nonvolatile memory, the microcontroller recognizes whether first data in a first physical block or second data in a second physical block is the latest version of data based on a validity table within the first physical block. The first physical block was originally used as a destination block for garbage collection. The second physical block was originally used as an active block to store write data from the host. The validity table shows whether storage units of the first physical block store valid or invalid data. The first data and the second data are data of the same logical address.

In another exemplary embodiment of the disclosure, a method for operating a data storage device, comprising the following steps: dividing storage space of a nonvolatile memory of the data storage device into a plurality of physical blocks; and when scanning the nonvolatile memory to reconstruct a mapping table between a host and the nonvolatile memory, recognizing whether first data in a first physical block or second data in a second physical block is the latest version of data based on a validity table within the first physical block. The first physical block was originally used as a destination block for garbage collection. The second physical block was originally used as an active block to store write data from the host. The validity table shows whether storage units of the first physical block store valid or invalid data. The first data and the second data are data of the same logical address.

Reconstruction of a mapping table is successfully completed by the aforementioned techniques.

In another exemplary embodiment of the disclosure, a method for garbage collection to be used in operating a data storage device is disclosed, which comprises: selecting a source block; selecting a destination block; copying data from the source block to the destination block; and when finishing using the destination block to collect valid data, writing end of block EOB information to the destination block and listing the destination block in a link list LinkList. The end of block EOB information includes a validity table bitMap and the validity table bitMap shows valid or invalid for every data in the destination block.

In another exemplary embodiment of the disclosure, a method for reconstructing a mapping table H2F to be used in operating a data storage device is disclosed, which comprises: according to a link list LinkList, selecting physical blocks from the data storage device to read end of block EOB information from the selected physical blocks; obtaining validity tables bitMap from the end of block EOB information to determine valid or invalid for data in the selected physical blocks; and recording mapping information of valid data to reconstruct a mapping table H2F.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A and FIG. 1B illustrate the physical space planning of a flash memory 100 in accordance with an embodiment of the disclosure;

FIG. 2 illustrates the concept of garbage collection;

FIG. 3 is a block diagram depicting a data storage device 300 in accordance with an exemplary embodiment of the disclosure;

FIG. 4 schematically depicts an unexpected condition for reconstructing a mapping table H2F according to a link list LinkList;

FIG. 5 depicts a solution to solve the problem of FIG. 4;

FIG. 6 is a flowchart depicting how to scan data blocks to reconstruct a mapping table H2F for the example of FIG. 5 in accordance with an exemplary embodiment of the disclosure;

FIG. 7 depicts another solution to solve the problem of FIG. 4; and

FIG. 8 is a flowchart depicting how to scan data blocks to reconstruct a mapping table H2F for the example of FIG. 7 in accordance with an exemplary embodiment of the disclosure.

### DETAILED DESCRIPTION OF THE INVENTION

The following description shows exemplary embodiments carrying out the invention. This description is made for the purpose of illustrating the general principles of the invention and should not be taken in a limiting sense. The scope of the invention is best determined by reference to the appended claims.

A nonvolatile memory may be a memory device for long-term data retention such as a flash memory, a magnetoresistive RAM, a ferroelectric RAM, a resistive RAM, a spin transfer torque-RAM (STT-RAM) and so on. The following discussion is regarding flash memory in particular as an example.

The flash memory is often used as a storage medium in today's data storage devices, for implementations of a memory card, a USB flash device, an SSD and so on. In another exemplary embodiment, the flash memory is packaged with a controller to form a multiple-chip package and named eMMC. A data storage device using a flash memory as a storage medium can be applied to a variety of electronic devices. The electronic device may be a smartphone, a wearable device, a tablet computer, a virtual reality device, etc. A central processing unit (CPU) of an electronic device may be regarded as a host operating a data storage device equipped on the electronic device.

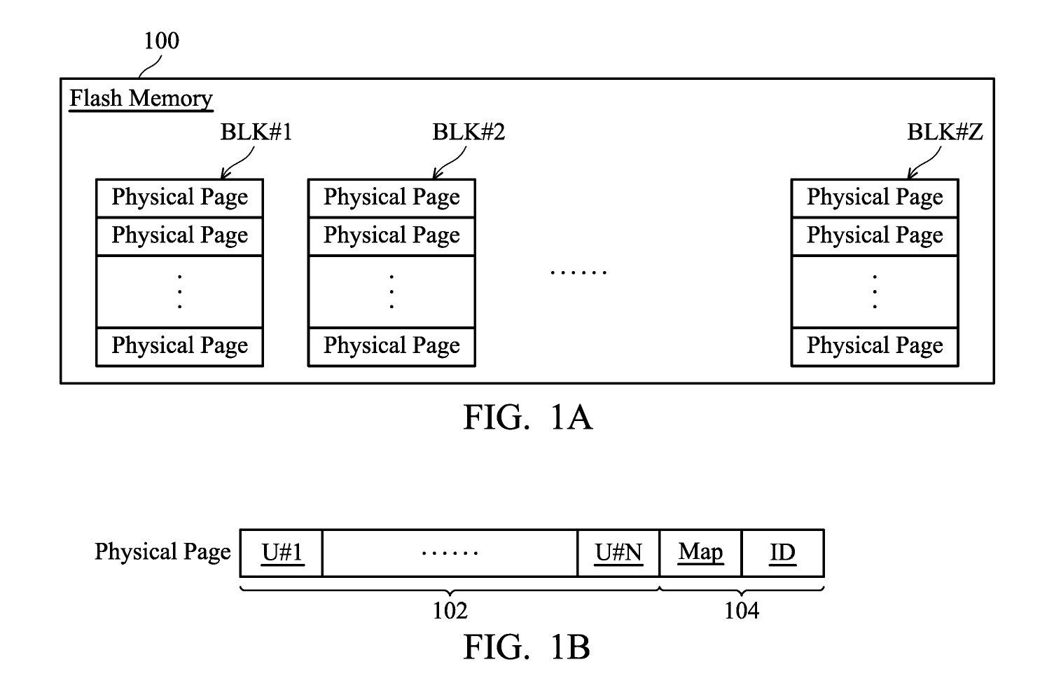

FIG. 1A and FIG. 1B illustrate the physical space planning of a flash memory 100 in accordance with an embodiment of the disclosure.

As shown in FIG. 1A, the storage space of the flash memory 100 is divided into a plurality of blocks (physical blocks) BLK#1, BLK#2 . . . BLK#Z, etc., where Z is a positive integer. Each physical block includes a plurality of physical pages, for example: 256 physical pages.

FIG. 1B details one physical page. Each physical page includes a data area 102, and a spare area 104. The data area 102 may be divided into a plurality of storage units U#1 . . . U#N to be separately allocated for data storage. There are many forms of logical addresses corresponding to the allocated storage units. For example, the allocated storage units may correspond to data storage of logical block addresses (LBAs) or global host pages (GHPs). In an exemplary embodiment, the data area 102 is 16 KB and may be divided into four 4 KB storage unit. Each 4 KB storage unit may be allocated to store data indicated by eight logical block addresses (e.g. LBA#0 to LBA#7) or one GHP. The spare area 104 is used to store metadata, including mapping information Map. Mapping information Map shows what logical addresses at the host side that the data in the storage unit U#1 . . . U#N corresponds to. For example, mapping information Map record 4 segments of LBAs (with each segment including to 8 LBAs) or 4 GHPs. In the following discussion, data storage is managed according to GHP, but not intended to be limited thereto. On particular physical pages, the spare area 104 further records a block identification code ID, and the details will be described later.

Under normal operations, mapping information of the flash memory 100 has to be dynamically organized into mapping tables (such as H2F, F2H). A mapping table H2F can be indexed by GHPs to show the physical addresses in the flash memory 100 corresponding to the different GHPs. For example, a physical address indicates a physical block number and a page or storage unit number. For a physical block, a mapping table F2H is provided to record the GHPs of the data stored in the different pages/storage units in the physical block. The mapping tables are an important basis for the host to operate the flash memory 100 and should be carefully maintained or rebuilt.

In particular, the flash memory 100 has a particular physical property. Updated data is not rewritten over the same storage space, but is stored in an empty space. The old data has to be invalidated. Frequent write operations make the storage space is flooded with invalid data. A garbage collection mechanism, therefore, is introduced.

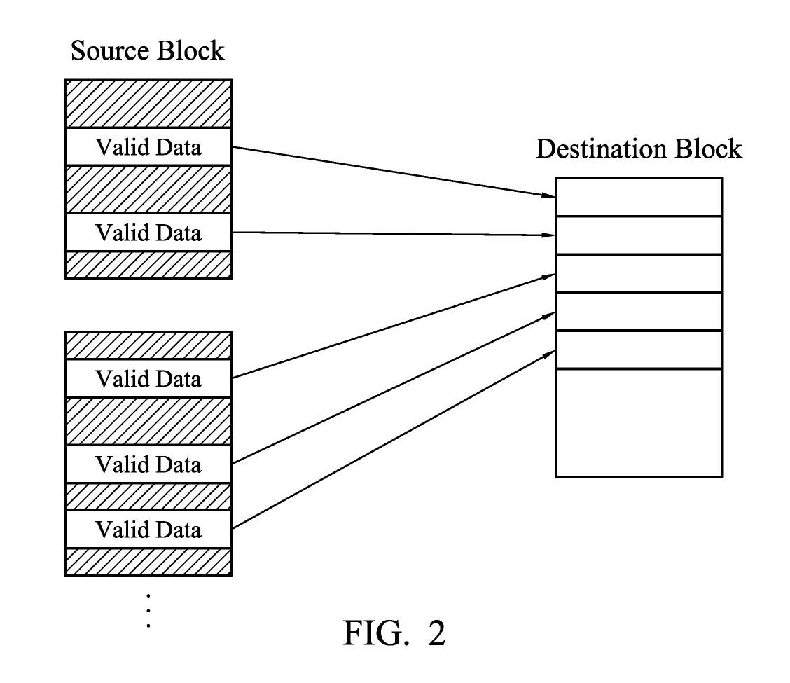

FIG. 2 illustrates the concept of garbage collection. The slashes indicate the invalid data. Valid data in source blocks is copied to a destination block. When valid data in a source block has been entirely copied to the destination block, the source block may be erased and redefined as a spare block. In another exemplary embodiment, the source block whose valid data has been copied to the destination block is redefined as a spare block is not erased until the spare block is selected to store data again. Such a garbage collection mechanism makes it more difficult to manage the mapping tables. A solution is introduced in the specification.

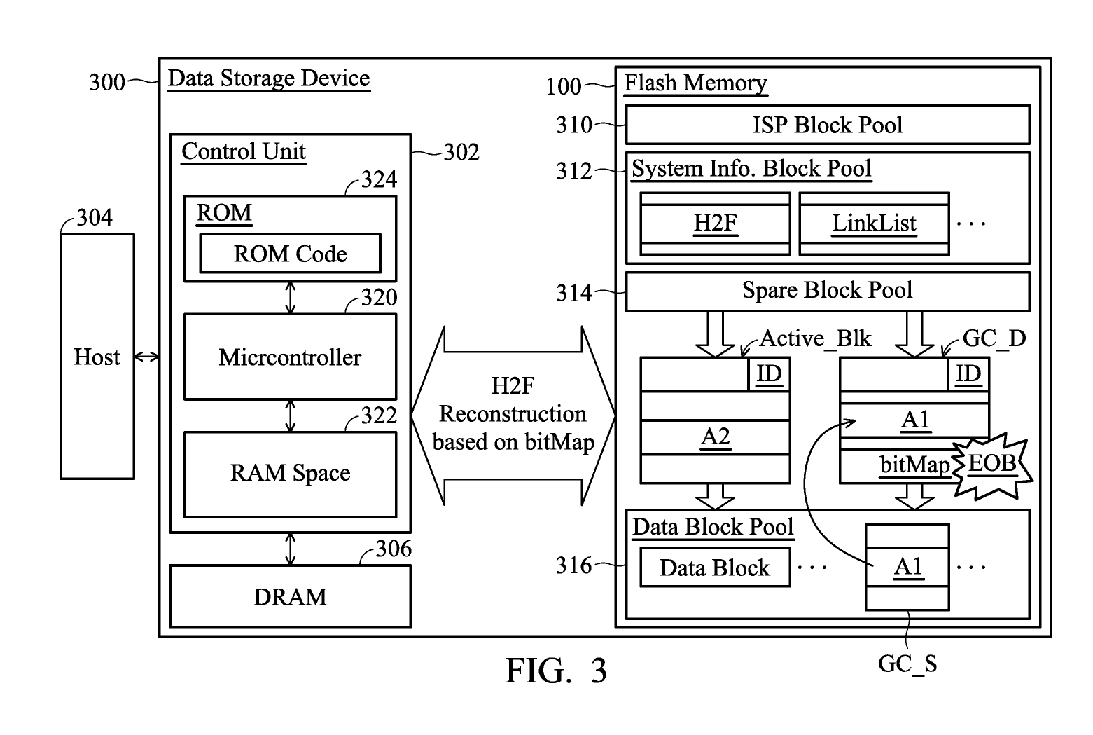

FIG. 3 is a block diagram depicting a data storage device 300 in accordance with an exemplary embodiment of the disclosure, which includes the flash memory 100 and a control unit 302. The control unit 302 is coupled between a host 304 and the flash memory 100 to operate the flash memory 100 in accordance with commands issued by the host 304. A DRAM 306 is optionally provided within the data storage device 300 as a data buffer.

The control unit 302 includes a microcontroller 320, a random access memory space 322 and a read-only memory 324. The random access memory space 322 may be implemented by an SRAM or a DRAM. In an exemplary embodiment, the random access memory space 322 and the microcontroller 320 are fabricated on the same die while the DRAM 306 is not fabricated on the same die with the microcontroller 320. The read-only memory 324 stores ROM code. The microcontroller 320 operates by executing the ROM code obtained from the read-only memory 324 or/and ISP (in-system programming) code obtained from an ISP block pool 310 of the flash memory 100. In the random access memory space 322, the microcontroller 320 may dynamically manage the mapping information that maps the LBAs/GHPs at the host 304 side to the physical space of the flash memory 100. A mapping table H2F and two F2H tables for an active block Active_Blk and a destination block GC_D may be used to maintain the mapping information. The mapping tables should be committed to the flash memory 100 for nonvolatile storage. The mapping table H2F should be stored in a system information block pool 312. Each mapping table F2H may be stored in the corresponding physical block (e.g., in the final page) as EOB (end of block) information.

FIG. 3 further shows that the physical blocks of the flash memory 100 are logically allocated to provide: the ISP block pool 310, a system information block pool 312, a spare block pool 314, a data block pool 316, an active block Active_Blk, and a destination block GC_D. The destination block GC_D is allocated to collect valid data for garbage collection. The blocks within the ISP block pool 310 store ISP code. The blocks within the system information block pool 312 store system information. In addition to the aforementioned mapping table H2F, a link list LinkList is also stored in the system information block pool 312. The active block Active_Blk is provided from the spare block pool 314 to receive data issued by the host 304. After the active block Active_Blk finishes receiving data, the active block Active_Blk is pushed into the data block pool 316 (i.e., is redefined as a data block). The destination block GC_D is also provided from the spare block pool 314. Source blocks (GC_S) may be selected from the data block pool 316. Valid data within source blocks GC_S is copied to the destination block GC_D by garbage collection. A source block GC_S whose valid data has been copied to the destination block GC_D may be redefined as a spare block and pushed into the spare block pool 314. The destination block GC_D filled with valid data may be pushed into the data block pool 316 (i.e. redefined as a data block). The order in which the data blocks are pushed into the data block pool 316 is recorded in the aforementioned link list LinkList. Before being pushed into the data block pool 316, the active block Active_Blk/destination block GC_D is further written EOB (end of block) information. After the EOB writing, the active block Active_Blk/destination block GC_D is attached to the link list LinkList as the latest record in the link list LinkList. The earlier a block is written EOB information, the earlier the block is attached to the link list LinkList. The later a block is written EOB information, the later the bock is attached to the link list LinkList. When data in two different blocks correspond to the same GHP, the data in the block that was written EOB information earlier than another block is regarded as invalid data.

When an abnormal power failure occurs and the mapping table H2F is lost, reconstruction of the mapping table H2F in the data storage device 300 is required. The reconstruction of the mapping table H2F includes scanning the data blocks in the order in which the data blocks are registered in the link list LinkList. The acquired mapping information may be mapping information Map stored in the spare area 104 of each physical page or a mapping table F2H stored in the EOB information of each data block. The scanning step is intended to know the physical space corresponding to different logical addresses (LBAs or GHPs). When data stored in different physical blocks correspond to the same logical address, the latest scanned content is judged to be valid. Compared with the aforementioned scanning direction, the mapping table H2F may be reconstructed by a reversed scanning direction in another exemplary embodiment and the earliest scanned content is judged to be valid.

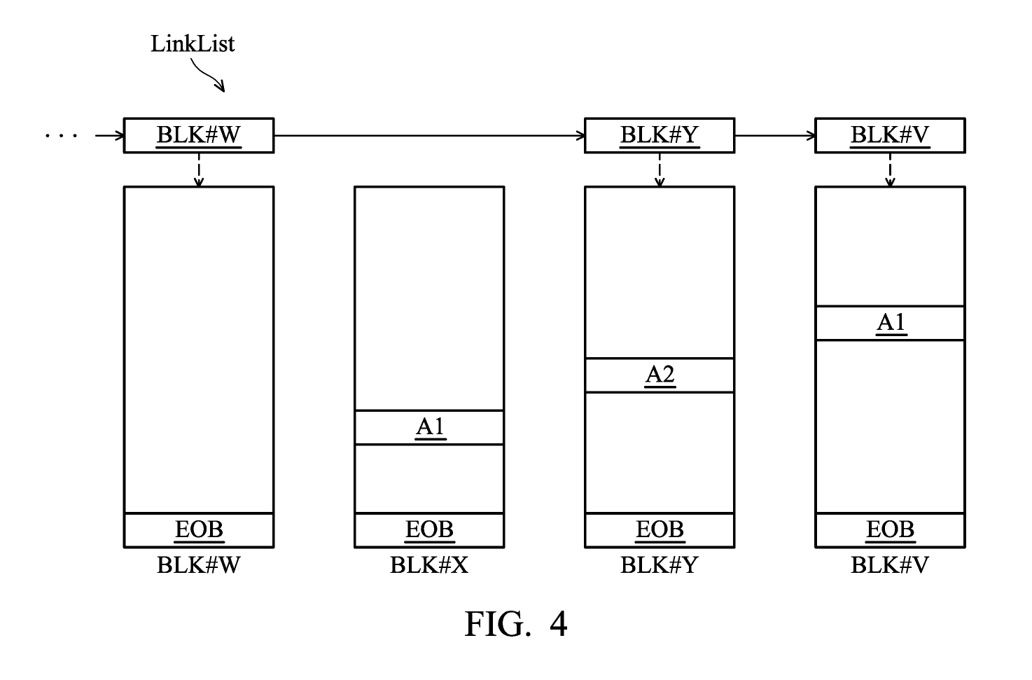

However, in a special case shown in FIG. 4, the aforementioned scanning process may not be able to reflect the actual data update order. For ease of understanding, the block latest registered in the link list LinkList is drawn on the right side of FIG. 4. Block BLK#X was originally registered in the link list LinkList. After garbage collection, only invalid data is left in the block BLK#X. The block BLK#X is removed from the link list LinkList after the destination block GC_D (i.e. BLK#V) for garbage collection is written EOB information and is registered into the link list LinkList. As shown, the data A1 is moved from the block BLK#X to the block BLK#V by the garbage collection. As for block BLK#Y, it was originally used as an active block Active_BLK. Because the EOB writing on block BLK#Y is earlier than the EOB writing on block BLK#V, the block BLK#Y is registered into the link list LinkList earlier than the block BLK#V. Data A2 in block BLK#Y is the updated version of data A1 and is written to the block BLK#Y as the block BLK#Y works as an active block Active_BLK. When an unexpected power failure event occurs, mapping table H2F is reconstructed by scanning data blocks according to the link list LinkList during a power recovery procedure. However, according to the link list LinkList, data A1 in block BLK#V is erroneously regarded as the latest version of data and the A2 in block BLK#Y is erroneously regarded as old data. Data management fails.

In order to correctly identify that data A2 in block BLK#Y is new and data A1 in block BLK#V is old, a solution is presented in the disclosure. Referring back to FIG. 3, in an exemplary embodiment of the disclosure, when writing EOB information to a destination block GC_D, a scan procedure is performed on the destination block GC_D 4 KB by 4 KB to create a validity table bitMap to mark valid/invalid data for every 4 KB storage unit in the destination block GC_D. Referring to the example of FIG. 4, the validity table bitMap will show that data A1 in the destination block GC_D (BLK#V) is invalid (in comparison with the updated version of data, A2). Based on the validity table bitMap, even if the active block Active_BLK (BLK#Y) is pushed into the data block pool 316 earlier than the destination block GC_D (BLK#V) and is registered in the link list LinkList earlier than the destination block GC_D (BLK#V), the old data A1 in the destination block GC_D (BLK#V) is prevented from being erroneously regarded as valid and the new data A2 in the block BLK#Y is correctly regarded as valid data. To deal with the unexpected power failure event, the validity table bitMap is considered when the microcontroller 320 reconstructs the mapping table H2F.

In the exemplary embodiment shown in FIG. 3, a block identification code ID is recorded in the spare area 104 of one physical page of each block to show that the block to be pushed into the data block pool 316 was originally used as an active block Active_Blk or a destination block GC_D. The validity table bitMap may be designed specifically for the destination block GC_D. When the block identification code ID shows that the data block being scanned for mapping table H2F reconstruction was originally used as a destination block GC_D, it means that the scanned block contains a validity table bitMap. The validity table bitMap is considered to determine the valid/invalid data in the destination block GC_D. In another exemplary embodiment, active block Active_Blk also includes the validity table bitMap design. The validity table bitMap is written to the corresponding physical block as EOB information. The validity tables bitMap are referred to for reconstruction of mapping table H2F during a power recovery process.

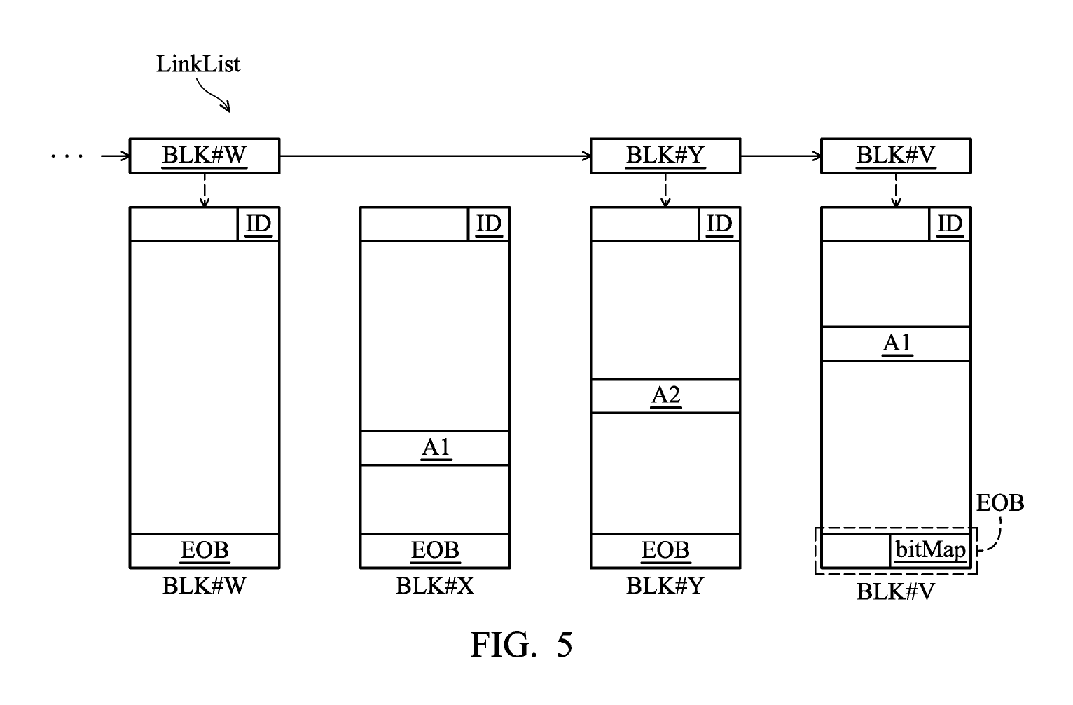

To solve the problem of FIG. 4, a solution is depicted in FIG. 5. A block identification code ID is recorded in the spare area 104 of the first physical page of each block. In an exemplary embodiment, the block identification code ID for an active block Active_Blk is “0” and the block identification code ID for a destination block GC_D is “1”. The block identification code ID of block BLK#Y shows that block BLK#Y was originally used as an active block Active_Blk. The block identification code ID of block BLK#V shows that block BLK#V was originally used as a destination block GC_D. During the reconstruction of the mapping table H2F, the spare areas (104) of the physical pages of the physical blocks are scanned for observation of the mapping information Map (indicating LBAs or GHPs) for the different storage units. When the scanning proceeds to block BLK#Y, it is obtained that logical address GHP_A maps data A2 in the block BLK#Y. When the scanning proceeds to block BLK#V, a validity table bitMap is taken into consideration because the block identification code ID shows that block BLK#V was originally used as a destination block GC_D. Because it is clearly record in the validity table bitMap that data A1 in block BLK#V is invalid, the logical address GHP_A is not erroneously redirected to data A1 in block BLK#V and is maintained mapping to data A2 in block BLK#Y. Data A2 in block BLK#Y is correctly recognized as the latest updated version of data.

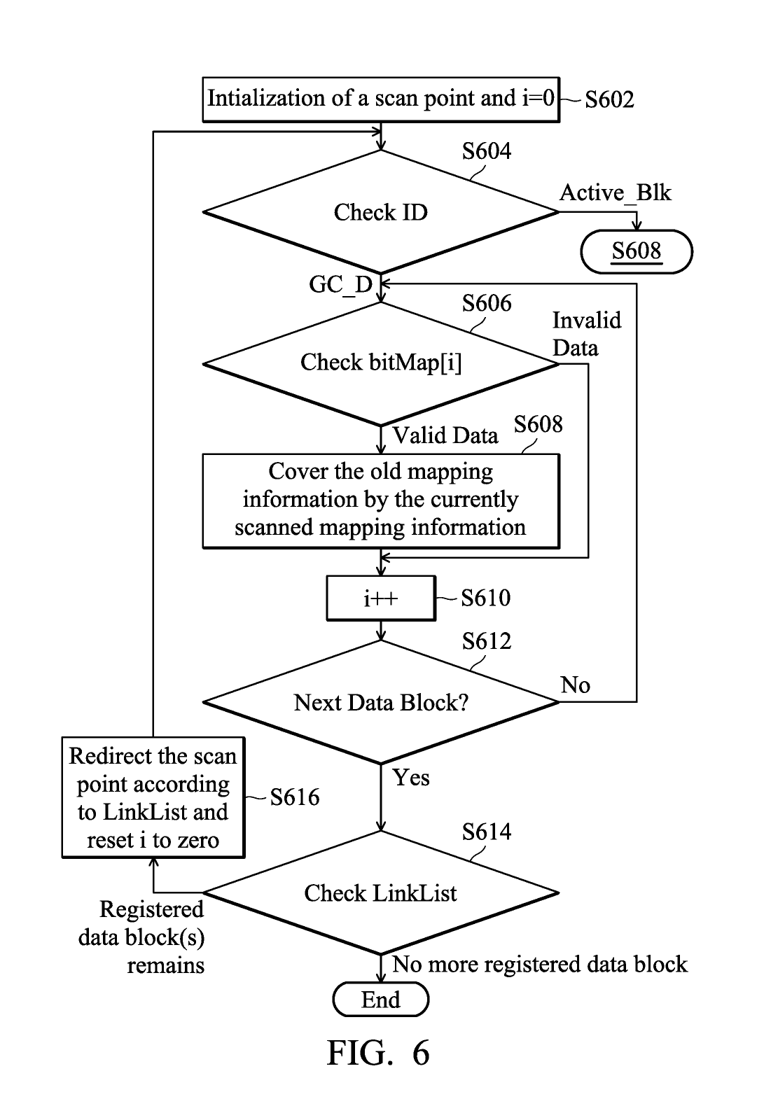

FIG. 6 is a flowchart depicting how to scan data blocks to reconstruct a mapping table H2F for the example of FIG. 5 in accordance with an exemplary embodiment of the disclosure. In step S602, a scan point is initialized. For example, the scan point may be initialized to the spare area 104 of the first physical page of the oldest data block registered in the link list LinkList. An index i (indicating the iₜₕ 4 KB storage unit of the scanned data block) may be initialized to zero. In step S604, the block identification code ID is checked. When the scanned data block was originally used as a destination block GC_D, step S606 is performed to check the iₜₕ content in the validity table bitMap (bitMap[i]). When it is obtained from the validity table bitMap that the iₜₕ storage unit of the scanned data block is valid, step S608 is performed. In step S608, the scanned mapping information covers the old mapping information, e.g., by redirecting the logical address to map the iₜₕ storage unit of the scanned data block. When it is obtained from the validity table bitMap (bitMap[i]) that the iₜₕ storage unit of the scanned data block is invalid, step S608 is skipped. In step S610, the index value i is increased by 1. It is checked in step S612 whether to proceed to scan the next data block. If not, the procedure returns to step S606 to check the validity table (bitMap[i]) for the next storage unit in the scanned data block. If it is yes in step S612, step S614 is performed to check the link list LinkList. When all data block registered in the link list Link LinkList have been scanned, the procedure finishes. If there are any data blocks waiting to be scanned, step S616 is performed according to the link list LinkList to direct the scan point to the spare area 104 of the first physical page of the next data block. The index i is reset to zero to indicate the first storage unit of the newly scanned data block. Then, the procedure returns to step S604.

When the block identification code ID recognized in step S604 shows that the scanned data block was originally used as an active block Active_Blk, step S606 is skipped and step S608 is performed. The mapping information is updated without checking the validity table bitMap (bitMap[i]). In conclusion, a review mechanism is introduced here to review the data in a scanned data block which was originally used as a destination block GC_D. The invalid data in the destination block GC_D, therefore, is prevented from being erroneously recognized as valid data. According to the scheme of FIG. 6, the mapping table H2F is correctly reconstructed.

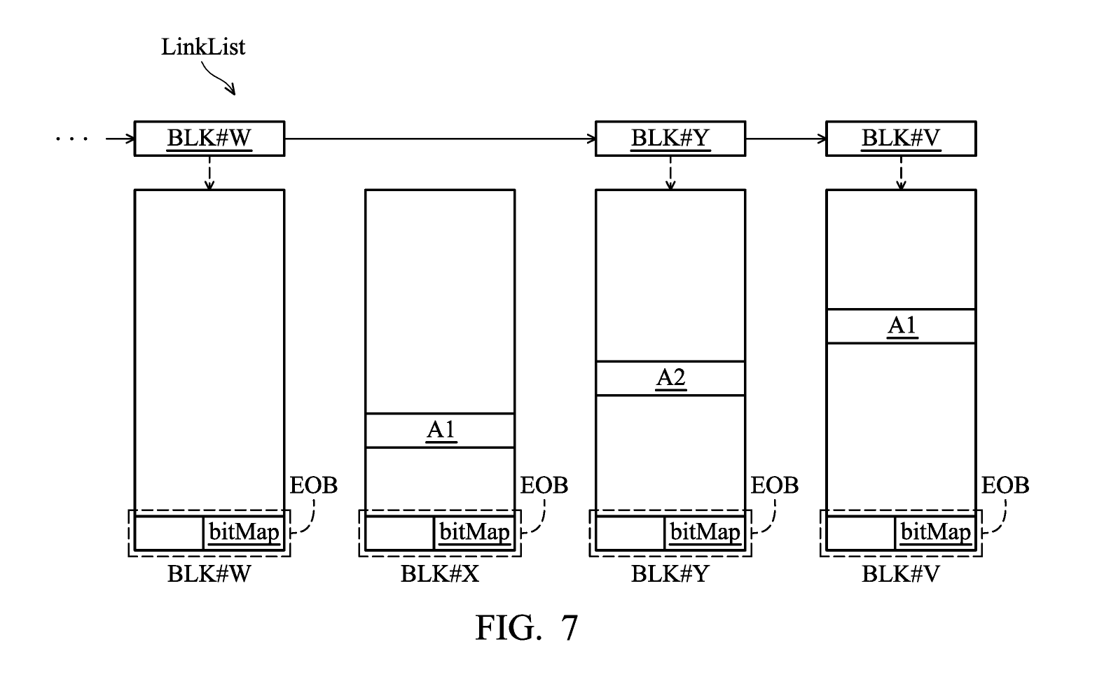

To solve the problem of FIG. 4, another solution is depicted in FIG. 7. The block identification code ID is unnecessary in this example. Each time EOB information is written into a block, a validity table bitMap is established as well. The validity table bitMap stored as EOB information of block BLK#Y shows that data A2 in block BLK#Y is valid data. The validity table bitMap stored as EOB information of block BLK#V shows that data A1 in block BLK#V is invalid data. During the reconstruction of the mapping table H2F, the spare areas (104) of the physical pages of the registered physical blocks are scanned according to the link list LinkList for observation of the mapping information Map (indicating LBAs or GHPs) for the different storage units. When the scanning proceeds to block BLK#Y, it is confirmed by checking the validity table bitMap of block BLK#Y that a logical address GHP_A maps data A2 in the block BLK#Y. When the scanning proceeds to block BLK#V, it is confirmed by checking the validity table bitMap of block BLK#V that data A1 in the block BLK#V is invalid. The logical address GHP_A, therefore, is not erroneously changed to map to data A1 in block BLK#V and is maintained to map to data A2 in block BLK#Y. Data A2 in block BLK#Y is correctly recognized as the latest updated version of data.

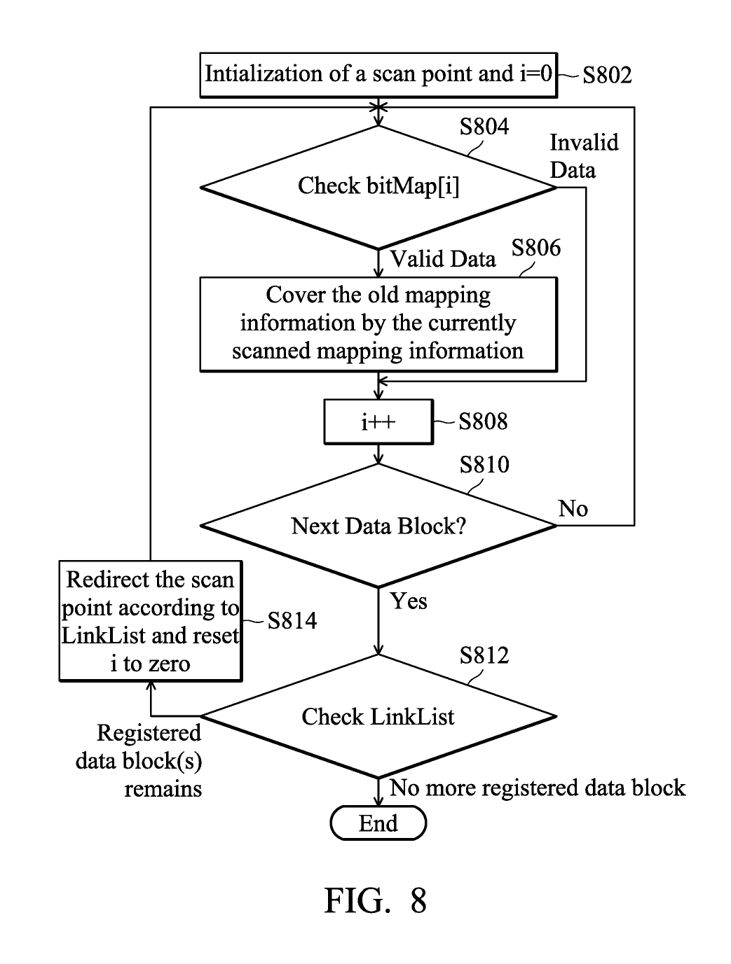

FIG. 8 is a flowchart depicting how to scan data blocks to reconstruct a mapping table H2F for the example of FIG. 7 in accordance with an exemplary embodiment of the disclosure. In step S802, a scan point is initialized. For example, the scan point may be initialized to the spare area 104 of the first physical page of the oldest data block registered in the link list LinkList. An index i (indicating the iₜₕ 4 KB storage unit of the scanned data block) may be initialized to zero. In step S804, the iₜₕ item in the validity table bitMap is checked (e.g. checking bitMap[i]). When it is obtained from bitMap[i] that the iₜₕ storage unit of the scanned data block is valid, step S806 is performed. In step S806, the scanned mapping information covers the old mapping information, e.g., by redirecting the logical address to map the iₜₕ storage unit of the scanned data block. When it is obtained from the bitMap[i] that the iₜₕ storage unit of the scanned data block is invalid, step S806 is skipped. In step S808, the index value i is increased by 1. It is checked by step S810 whether to proceed to scan the next data block. If not, the procedure returns to step S804 to check the iₜₕ item in the validity table bitmap (e.g. checking bitMap[i]) for the next storage unit in the scanned data block. If it is yes in step S810, step S812 is performed to check the link list LinkList. When all data blocks registered in the link list Link LinkList have been scanned, the procedure finishes. If there are any data blocks waiting to be scanned, step S814 is performed according to the link list LinkList to direct the scan point to the spare area 104 of the first physical page of the next data block. The index i is reset to zero to indicate the first storage unit of the newly scanned data block. Then, the procedure returns to step S804.

Other techniques that use the aforementioned concepts to reconstruct a mapping table are within the scope of the disclosure. Based on the above contents, the present invention further relates to methods for operating a data storage device.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a nonvolatile memory, comprising a plurality of physical blocks; and
a microcontroller, recognizing whether first data in a first physical block or second data in a second physical block is the latest version of data based on a validity table of the first physical block when scanning the nonvolatile memory to reconstruct a mapping table between a host and the nonvolatile memory,
wherein:
the first physical block was originally used as a destination block for garbage collection;
the second physical block was originally used as an active block to store write data from the host;
the validity table shows whether storage units of the first physical block store valid or invalid data; and
the first data and the second data are data corresponding to the same logical address.

2. The data storage device as claimed in claim 1, wherein:
the microcontroller establishes the validity table when writing end of block information into the first physical block.

3. The data storage device as claimed in claim 2, wherein:
the microcontroller stores the validity table in a final physical page of the first physical block.

4. The data storage device as claimed in claim 2, wherein:
the microcontroller manages a link list to record the order in which the physical blocks store end of block information; and
the microcontroller further stores the link list in the nonvolatile memory for nonvolatile storage.

5. The data storage device as claimed in claim 4, wherein:
the microcontroller further manages an ID field in each physical block to show whether a physical block stored data as a destination block for garbage collection or an active block.

6. The data storage device as claimed in claim 5, wherein:
when scanning the nonvolatile memory to reconstruct the mapping table between the host and the nonvolatile memory, the microcontroller scans the physical blocks in the order recorded in the link list and recognizes that the first block was originally used as a destination block for garbage collection based on the ID field of the first physical block and the second block was originally used as an active block based on the ID field of the second physical block.

7. The data storage device as claimed in claim 6, wherein:
when end of block information of the second physical block is written to the second physical block earlier than end of block information of the first physical block is written to the first physical block, the microcontroller records the second physical block in the link list earlier than recording the first physical block in the link list.

8. The data storage device as claimed in claim 7, wherein:
regarding the first physical block storing end of block information later than the second physical block storing end of block information, the microcontroller invalidates the first data in the validity table when writing end of block information to the first physical block.

9. A method for operating a data storage device, comprising:
dividing storage space of a nonvolatile memory of the data storage device into a plurality of physical blocks; and
when scanning the nonvolatile memory to reconstruct a mapping table between a host and the nonvolatile memory, recognizing whether first data in a first physical block or second data in a second physical block is the latest version of data based on a validity table of the first physical block,
wherein:
the first physical block was originally used as a destination block for garbage collection;
the second physical block was originally used as an active block to store write data from the host;
the validity table shows whether storage units of the first physical block store valid or invalid data; and
the first data and the second data are data corresponding to the same logical address.

10. The method as claimed in claim 9, further comprising:
establishing the validity table when writing end of block information into the first physical block.

11. The method as claimed in claim 10, further comprising:
storing the validity table in a final physical page of the first physical block.

12. The method as claimed in claim 10, further comprising:
managing a link list to record the order in which the physical blocks store end of block information; and
storing the link list in the nonvolatile memory for nonvolatile storage.

13. The method as claimed in claim 12, further comprising:
managing an ID field in each physical block to show whether a physical block stored data as a destination block for garbage collection or an active block.

14. The method as claimed in claim 13, further comprising:
when scanning the nonvolatile memory to reconstruct the mapping table between the host and the nonvolatile memory, scanning the physical blocks in the order recorded in the link list and recognizing that the first block was originally used as a destination block for garbage collection based on the ID field of the first physical block and the second block was originally used as an active block based on the ID field of the second physical block.

15. The method as claimed in claim 14, further comprising:
recording the second physical block in the link list earlier than recording the first physical block in the link list when end of block information of the second physical block is written to the second physical block earlier than end of block information of the first physical block is written to the first physical block.

16. The method as claimed in claim 15, wherein:
regarding the first physical block storing end of block information later than the second physical block storing end of block information, the first data is invalidated in the validity table when end of block information is written to the first physical block.

17. The method as claimed in claim 16, wherein:
when the second physical block is obtained from the link list earlier than the first physical block, the second block is scanned earlier than the first block and a logical address is mapped to the second data in the second physical block to reconstruct the mapping table.

18. The method as claimed in claim 17, wherein:
when the first physical block is obtained from the link list later than the second physical block, the first block is scanned later than the second block and the logical address keeps mapping to the second data of the second physical block because the invalidity table shows that the first data in the first physical block is invalid.

19. A method for garbage collection to be used in operating a data storage device, comprising:
selecting a source block;
selecting a destination block;
copying data from the source block to the destination block; and
when finishing using the destination block to collect valid data, writing end of block EOB information to the destination block and listing the destination block in a link list LinkList,
wherein the end of block EOB information includes a validity table bitMap and the validity table bitmap for every data in the destination block to indicate valid data or invalid data.

20. A method for reconstructing a mapping table H2F to be used in operating a data storage device, comprising:
according to a link list LinkList, selecting physical blocks from the data storage device to read end of block EOB information from the selected physical blocks;
obtaining validity tables bitMap from the end of block EOB information to determine valid data and invalid data in the selected physical blocks; and
recording mapping information of valid data to reconstruct a mapping table H2F.
